(19) United States
(12) Patent Application Publication
(10) Pub. No.: US 2003/0003963 A1
(43) Pub. Date: Jan. 2, 2003

(54) Telephony device comprising a display screen on which adjustment parameters appear

(76) Inventor: Nicolas Ringot, Le Mans (FR)

Correspondence Address: Philips Electronic North America Corporation, 580 White Plains Road, Tarrytown, NY, 10591, US

(21) Appl. No.: 10/169,818

(22) PCT Filed: Nov. 13, 2001
(86) PCT No.: PCT/EP01/13185

(30) Foreign Application Priority Data
Nov. 14, 2000 (FR) 00/14623

(51) Int. Cl. H04B 1/38

(52) U.S. Cl. 455/566; 455/550

(57) ABSTRACT

This telephony device (1) comprises a display screen (5) on which sound adjustment parameters are visible. On this screen are shown an index (21), (22) and (23) which is moved along a path (31), (32) and (33) respectively, to indicate the value of the parameter. In this way a kind of equalizer is formed.

The invention relates to a telephony device comprising a display screen on which adjustment parameters are visible.

Telephony devices, notably those of the mobile type, have sound characteristics of which the quality becomes better and better. Thus it becomes ever more necessary to adjust the audio parameters.

A device of this type is known from French patent document 2 764 466. In this document a proposal is made to realize a frequency equalizer with the aid of digital filters which each have a gain that can be adjusted as a function of the desired sound quality.

The present invention proposes a device of the type defined in the opening paragraph, which permits to easily adjust these parameters by using ergonomy that is pleasant to the user.

For this purpose, such a device is characterized in that the value of these parameters is shown on said screen by a movable index which indicates said value.

These and other aspects of the invention are apparent from and will be elucidated, by way of non-limitative example, with reference to the embodiment(s) described hereinafter.

### In the drawings:

FIG. 1 shows a device according to the invention,

FIG. 2 shows a diagram of this device,

FIG. 3 shows a display of the parameters according to the invention.

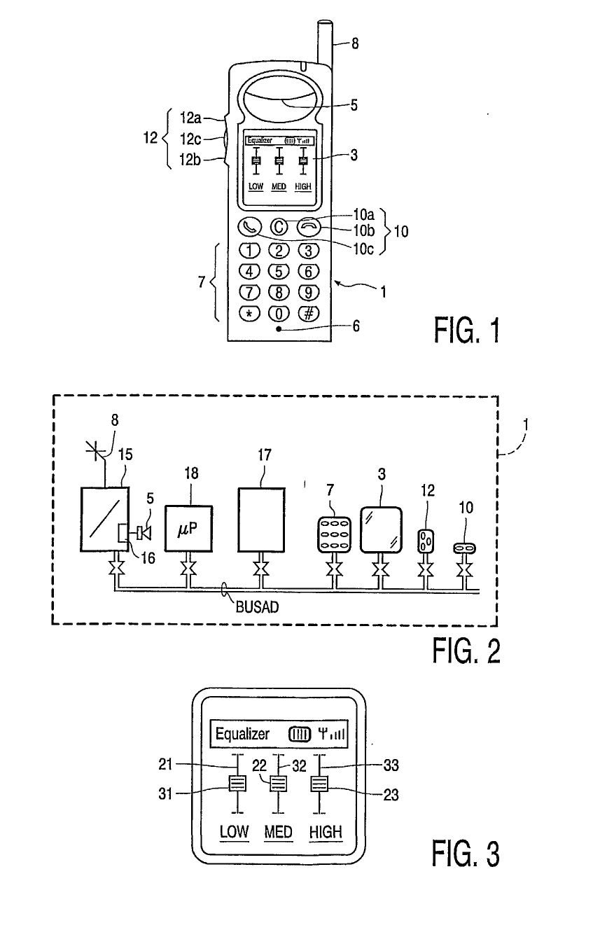

In FIG. 1 is shown a mobile telephony device formed by a housing 1 which notably comprises a screen 3, a loudspeaker 5, a microphone 6, a keypad 7, an antenna 8, a first set of buttons 10 located on the front face and a second set 12 located on the side face of the housing containing said device.

In FIG. 2 is shown a simplified diagram of this mobile telephony device 1. This device is formed, in essence, by a transceiver assembly 15 which permits to transmit and receive data. For this purpose it is connected to the antenna 8. This assembly 15 comprises an audio amplifier 16 which applies the signals to the loudspeaker 5. This assembly 15, as well as the various elements already mentioned before and important for the invention, that is to say, the screen 3, the keypad 7 and the two button assemblies 10 and 12, are managed by a processor 18 which co-operates with a memory 17.

As this type of device has a good audio quality, the user may feel the need to adjust the sound by influencing, for example, various dialing tone ranges: the low-pitched, the high-pitched and also the medium-pitched.

According to the invention, for adjusting the level of these parameters, the user acts on indices (or cursor) shown in detail in FIG. 3 and carrying the references 21, 22 and 23, respectively, for the low-pitched, medium-pitched and high-pitched tones. These indices are moved along a path 31, 32 and 33, respectively, by applying the keys of the assemblies 10 and 12 as this will be explained. The position of this index along the path gives a good indication of the value of the parameter. Some of these indices are made to appear on the screen, so that the user has the relative values of these parameters opposite each other.

The key assembly 12 comprises three control contacts: the contact 12a is situated in the upper part of the assembly, the contact 12b in the lower part and the contact 12c in the middle part.

A depression of key 12c permits to select in a cyclic manner one of said ranges. Then a depression of key 12a causes the index of the selected range to move up via a notch. A depression of key 12c has the opposite effect, that is to say, that it makes the index move down.

The key assembly 10 comprises three keys 10a, 10b and 10c. The key 10a permits to leave the adjustment menu of the audio parameters. The key 10b, after being depressed for a long time, switches off the telephony device. A depression of key 10c permits to take the line and to listen to the person you are speaking to with the audio parameters thus chosen.

The invention thus offers the advantage that this adjustment is made in a totally intuitive manner by solely basing oneself on three contacts 10a, 12b and 12c. Because of the fact that these keys are on the side face, it is possible for the user to handle them in an easy and pleasant manner.

The aspect in the form of an equalizer represented by the place of the indices gives an idea of the importance of the level of the various ranges and thus gives a comfortable impression.

1. A telephony device comprising a display screen on which adjustment parameters are visible, characterized in that, the value of these parameters is represented on said screen via a movable index which indicates said value.

2. A device as claimed in claim 1, characterized in that, it comprises at least a first control for making said index vary in one direction.

3. A device as claimed in claim 2, characterized in that, it comprises a second control for making said index vary in the other direction.

4. A device as claimed in one of the claims 1 to 3, characterized in that, it comprises a third control for selecting said parameters whose value is represented by the position of said index.

5. A device as claimed in one of the claims 1 to 4, characterized in that, said controls are found on the side face of the housing containing said device.

6. A device as claimed in one of the claims 1 to 5, characterized in that at least two parameters are visible on said screen.
